(19) United States
(12) Patent Application Publication
(10) Pub. No.: US 2007/0103566 A1
(43) Pub. Date: May 10, 2007

(54) Methods and devices for image and ancillary data capture and output

(76) Inventors: Naveen Aerrabotu, Gurnee, IL (US); Sanjay Gupta, Lakewood, IL (US); Balakumar Jagadesan, Glendale Heights, IL (US)

Correspondence Address: MOTOROLA INC, 600 NORTH US HIGHWAY 45, ROOM AS437, LIBERTYVILLE, IL, 60048-5343, US

(21) Appl. No.: 11/269,967

(22) Filed: Nov. 9, 2005

(51) Int. Cl. H04N 5/76

(52) U.S. Cl. 348/231.3

(57) ABSTRACT

Described herein is an image capturing device such as a mobile communication device and methods for capturing and transmitting data. The methods include capturing an image to generate a data file, capturing a ancillary data embedded in a signal of a digital tag to retrieve the data of the digital tag substantially synchronously with capturing the image, processing the ancillary data of the digital tag to combine it with the data file to generate a combined file and transmitting the combined file. Transmitting the combined file to any receiving application is further provided, including to a printer application that prints an image on paper having an embedded digital tag and also transfers the ancillary data embedded in the signal of the digital tag to the embedded digital tag. Ancillary data may include copy protection data.

### FIELD OF THE INVENTION

The present invention relates to image and ancillary information capturing, and more particularly to processing the ancillary information to combine it with the image information to generate a combined file.

### BACKGROUND OF THE INVENTION

Mobile communication devices are being increasingly equipped with image capturing features. Mobile communication devices oftentimes include still cameras and/or video cameras. Users can send visual data in the form of photos and video clips wirelessly, may transfer them to another device such as a personal computer, laptop or PDA, or may store them in the mobile communication device.

Oftentimes, the photographer or cinematographer may generate documentation regarding a photo or video. For archive purposes, or any other purpose, information such as a location description, subject identification, and time and date data may be useful. This ancillary information relating to a still photo or video can also include, for example, GPS information, text such as a scene description, camera details, photographer details, and voice data. There may be no limit to the types of ancillary information that may be associated with a still photo or video. Ancillary information may be added to an image by default features such as a time or date stamp. Any additional information is typically typed into the device and maintained as a separate file. Ancillary and additional information may be transmitted, along with a captured image as a separate file for example as in an email message. If a photo is printed on paper, ancillary information relating to the photo is affixed to the paper in the form of a written label or is hand-written onto the paper.

The visual data information of a still photo or a video may be captured in a variety of places. In addition to the opportunity to capture visual data information, entities associated with such places as stadiums and museums may provide ancillary information as well. As mentioned, image capturing devices such as digital cameras and video technologies support some manners in which to capture ancillary data such data and time stamps. Other ancillary information may be in the form of a plaque or other media or may be an audio recording. A photographer or cinematographer when capturing visual data, may also capture ancillary information by photographing other images. Were the image capturing device to be a mobile communication device such as a cellular telephone, the photographer or cinematographer may add and store audio data and/or written data typed onto a keypad and stored in a separate ancillary data file. Since the capture of ancillary information is ad hoc, in general, a photographer or cinematographer must find a way to capture, store and transmit the ancillary information in addition to the visual information captured by an image capturing device.

### BRIEF DESCRIPTIONS OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 shows a terminal, such as a mobile communication device;

FIG. 2 shows the reverse side of device 102 shown in FIG. 1;

FIG. 3 is a flowchart that includes two embodiments of the file content of the technology disclosed herein;

FIG. 4 shows where the device can transmit the entire combined file or all or some of the component parts of the combined file; and

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

As vendors, proprietors and other entities provide opportunities for photo and video capturing, they may provide ancillary information for capture in the form of RFID tags or other electromagnetic digital tags. Along with image capturing opportunities, RFID tags may be available as a source of ancillary information in addition to traditional forms of ancillary information. Alternatively, RFID tags may be provided as the only source of ancillary information by particular venues, during particular events, in particular environments, or in particular applications. In any circumstance in which the data of an RFID tag, or the data of another similar device may be captured, described herein are methods and a device for the substantially simultaneous capture of both visual data and digital tag data.

Disclosed is an image capturing device and methods for capturing, processing and transmitting data, in particular that of ancillary information, synchronously with visual data. The methods include capturing visual data information, either a still photo or a video image and substantially simultaneously capturing data embedded in a signal from a digital tag, and then combining the data from the two sources to form a combined file. It is understood that when discussing an image, that a sequence of images is included in the discussion as well.

RFID (radio frequency identification) technology or other similar technology incorporates the use of electromagnetic or electrostatic coupling in the radio frequency (RF) portion of the electromagnetic spectrum to embed data in an RFID tag. Besides the low cost of RFID tags, a major advantage of RFID is that it does not require direct contact or line-of-sight scanning. Also, it can be scanned at substantial distances from the scanner. An RFID system includes three components: an antenna and transceiver (often combined into one reader) and a transponder of the tag. The antenna uses radio frequency waves to transmit a signal that activates the transponder of the digital tag. When activated, the digital tag transmits data back to the antenna and remote device. The digital tag can carry a lot of information. Depending upon its use, it can carry a small amount of data such as a name and address or larger amounts of data such as product maintenance instructions. It can carry complex information such as a product manual. Passive tags require no internal power source, whereas active tags require a power source. It is understood that other similar technologies are included in this discussion.

In an image capture device, capturing the image and processing the data embedded in the signal of an RFID tag to retrieve data of the digital tag can be provided substantially simultaneously. Processing of additional ancillary information is also provided. The additional ancillary information is also combined with the combined file of visual data and digital tag data.

The combined file may be transmitted in different ways and to different types of recipient devices. The combined file may be sent to a printer with digital tag writing capability so that the visual data is separated from the ancillary information and they are separately written to a sheet of paper including an embedded digital tag. The ancillary information may include data indicating copy protection. The combined file may also be sent over the Internet and/or by cellular or other wireless or wired communication. Accordingly, a digital tag may contain website links which could trigger web pages for advertisements on devices such as mobile phones.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

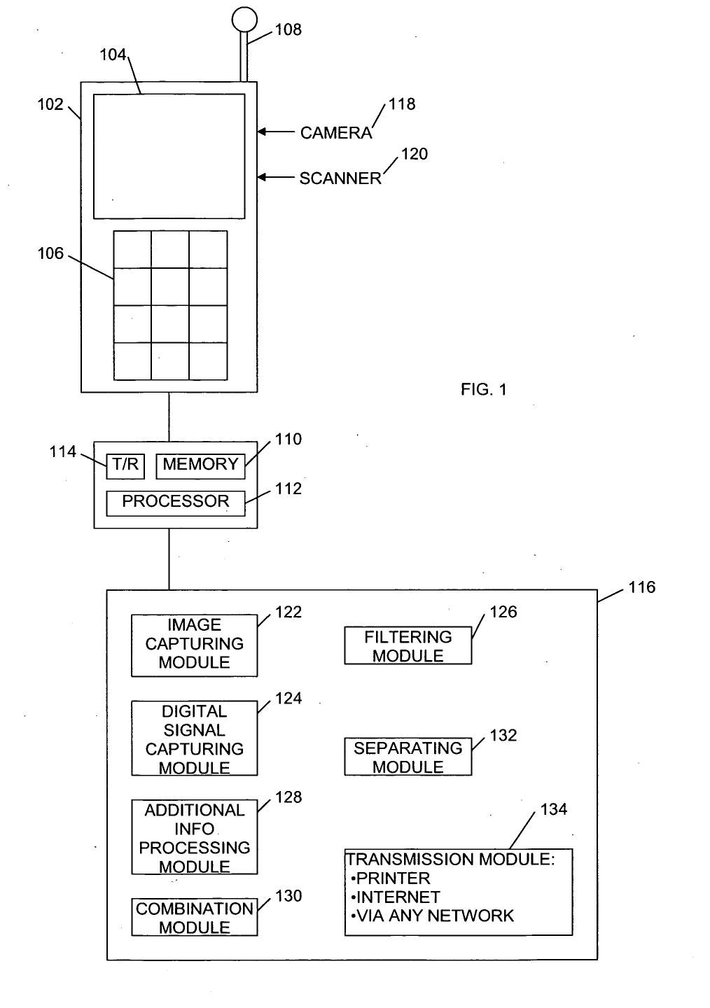

FIG. 1 shows an image capturing terminal, such as a mobile communication device. FIG. 1 depicts an embodiment of a terminal that is a wireless communication device 102, and in particular, a cellular radiotelephone. The mobile communication device 102 represents a wide variety of communication devices that have been developed for use within various networks. Such communication devices include, for example, handheld cellular telephones, messaging devices, mobile telephones, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless and wired communication technologies include the capability of transferring high content data. For example, the mobile communication device 102 can provide Internet access and/or multi-media content access.

The electronic device 102 typically includes a display device 104, input capability such as a key pad 106, an antenna 108, a memory 110, a processor 112, a transmitter and receiver 114, and modules 116 that can contain instruction modules that are hardware or software and that will be discussed in detail below. While these electronic components of the terminal are shown as part of the device, any of their functions in accordance with this disclosure may be wirelessly or via wires, transmitted to and received from electronic components remote to the device 102.

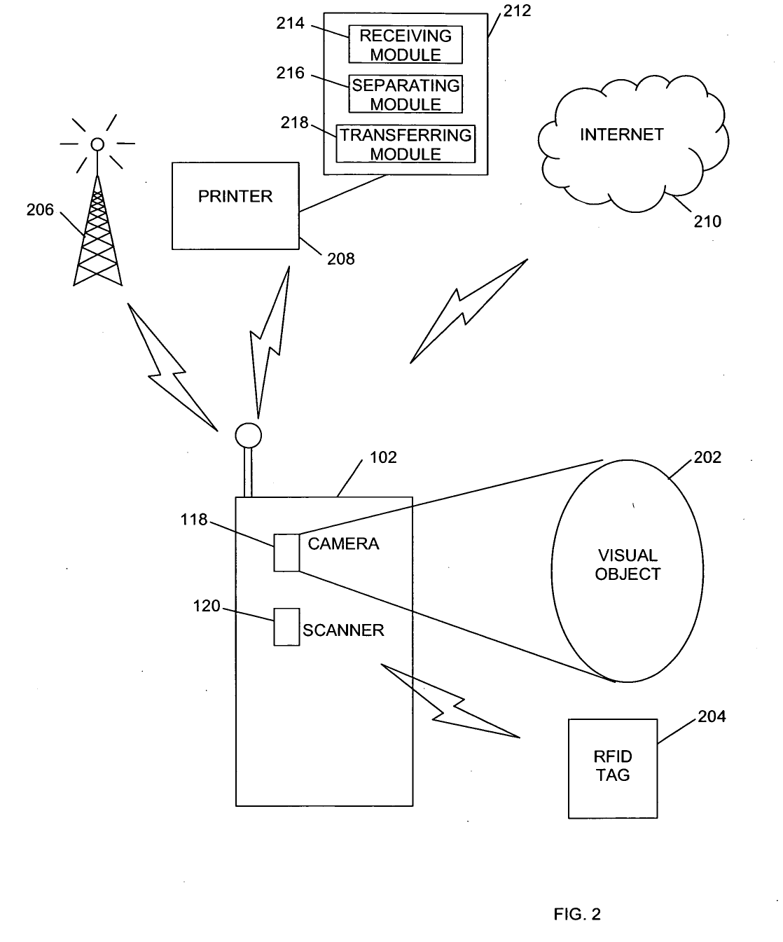

On the reverse side of device 102 shown on FIG. 1 are a camera 118 and a digital tag scanner (or interrogator) 120. Typically the camera and scanner are on the reverse side of the device but it is understood that they may be in different positions than those shown and the positions of each may be independent of one another. The camera and scanner are shown in more detail in FIG. 2. FIG. 1 further illustrates modules 116 associated with the device that may be in the form of software or hardware. The modules may be installed at manufacture, may be downloaded and can also include default settings and/or user preference settings. The image capturing module 122, the digital signal capturing module 124, the filtering module 126, the additional information processing module 128, the file combination module 130, the separating module 132 and the transmission module 134 that transmits all or part of the combined file to any receiving application will be understood in the context of the discussion below.

FIG. 2 shows the reverse side of device 102 shown in FIG. 1. Still camera or video camera 118 and scanner 120 are shown. It is understood that the camera 118 and scanner 120 may be of any type suitable for carrying out the methods described herein and operation of the device as described herein. The camera 118 may be two cameras, a still camera and a video camera, or one camera may be a combination of both. In any event, the camera captures an image or a plurality of images 202.

The scanner 120 is of the type that can capture signal data embedded in one or more digital tags 204, such as an RFID tag described above. The digital tag may be in the same line of vision as the visual object but does not have to be. Since the digital tag is a transponder activated by a transceiver of the scanner, the digital tag may be positioned in any proximity where it can be excited by the transceiver.

FIG. 2 further illustrates that the transceiver 114 can communicate with any receiver in any manner. For example, device 102 can communicate with a cellular tower 206, a printer 208, and the Internet 210. The device may be configured to communicate wirelessly or in a wired manner. FIG. 2 further illustrates modules 212 associated with the printer that may be in the form of software or hardware. The modules may be installed at manufacture, may be downloaded and can also include default settings and/or user preference settings. The receiving module 214, the separating module 216 and the transferring module 218 will be understood in the context of the discussion below.

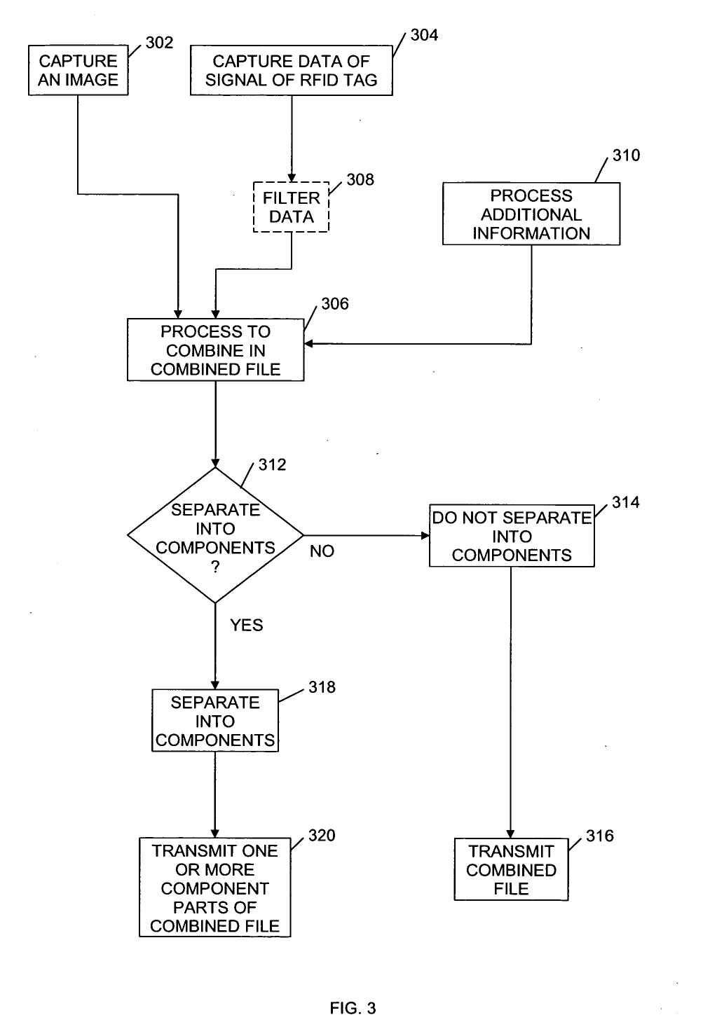

FIG. 3 is a flowchart that includes two embodiments of the technology disclosed herein. They are combined since the second is an augmentation of the first. Both embodiments provide an image capturing device to capture an image 302. Substantially synchronously with the capturing of an image, the image capturing device captures 304 data of a signal of a digital tag. As mentioned above, the digital tag is a transponder having a signal that carries data. Data within the tag can be programmed to carry any type of information, including but not limited to, links to websites, software modules and read-only files. The data in the tags can be read by suitable scanners wirelessly from a distance. Like any wireless communication, digital tags or RFID also uses a range of frequency bands, low, intermediate and high frequency to transfer data in a non-contact fashion.

Digital tags such as RFID tags may be strategically placed in locations by vendors or other entities for the purpose of providing information to the public or other groups. For example, ancillary information of a digital tag can include annotated voice tags that could provide additional data for handicapped persons. In addition to “Help Signs,” a digital tag can carry a telephone number that provides help on campus or at schools.

The scanner 120 shown in FIGS. 1 and 2, can be of any sort that captures data from the signal of a digital tag. Depending upon the intended distance for a scan, for example, and the needs of the application, the frequency range may be low, medium or high. A high frequency digital tag system has a long reading range and a higher reading speed. A particular application may require an active tag that is battery powered and hence expensive. On the contrary, low and intermediate frequency digital tags are less expensive passive devices, with a lower readying range and transfer rate.

The power available to the scanner, reader or interrogator may determine the range and efficiency of the data retrieval. As mentioned above, a digital tag such as an RFID tag does not require direct contact or line-of-sight scanning. Generally, the electromagnetic wave delivered from the antenna of the digital tag extends into the space surrounding it and hence the strength diminishes with the distance. However, when the image capturing device is active, the focal length of the image can be aligned with a digital tag or RFID pilot to improve signal-to-noise ratio and power conservation. Accordingly, there may be an elimination of multiple-RFID source interferences. Also, it is possible to choose different power levels based on the scanning application needs. The capability of scanner 120 may depend upon its intended application. It is understood that any type of digital tag scanner or scanners may be used along with the image capturing device, as well as those that manage adequate power in the direction of the digital tag.

Still referring to FIG. 3, the capture of an image or sequence of images to generate video, synchronously with the capture of data of the signal of the digital tag are shown. The two data files can be combined into a single combined file 306, or other file structure that similarly provides the ability to combine the image or sequence of images captured and the data from the digital tag. The combined file can be in the form of metadata however the combined file 306 may be any suitable format including an Exchangeable Image File Format (EXIF).

The EXIF file specification data can be broadly divided into three categories, structure of image data files, header tags for fields used by this standard, and definition and management of format versions. Some common features that have been standardized are time and date tags (not to be confused with digital tags such as RFID tags), compression and format tags, thumb-nail tags, GPS data and JPEG special handling tags. The EXIF format furthermore has the provision to hold more information such as the ancillary data of the digital tag plus additional data including photographic details, scene description, written and audio comments, and software required to handle the image.

A still picture captured from a camera is usually in the JPEG format. The JPEG2000 format is also possible. The JPEG file could have header information that may contain additional data from the RFID source or EXIF header could be added to the JPEG file. It is understood that any format for a still image or a sequence of images is within the scope of this discussion.

The EXIF file format can include one or more an additional fields such as RFID information field where the additional information derived from an RFID source could be added to the picture data. The RFID field may have multiple entries to accommodate multiple RFID information to be stored, i.e. a picture could have multiple RFID derived information. For example, three multiple people/objects in a photograph could have multiple RFID tags and the scanner could get the information from all the objects/people and put in the EXIF and potentially as part of the RFID field in EXIF. It is understood that any number of fields can be provided in an EXIF format. It is further understood, that any standard format can include header type fields that can contain the ancillary data captured from a digital tag such as a RFID tag and/or additional data.

Processing the combined file 306 can include providing the data of the digital tag to the EXIF file. In one step of the processing, filtering 308 the data from the digital tag may be provided. Filtering out information and filtering in information may both be provided independently or in any combination thereof. The filtering may be based on user preferences, for example, where a user may configure a limit on the size of the RFID information to be added to the EXIF. Alternatively the filtering may be automated as part of processing the combined file 306. The standard EXIF file includes standard fields, which can be expanded in number and in size to include data of any type.

In the second embodiment illustrated in FIG. 3, additional information may be provided 310 in processing the combined file 306. The additional data may come from any source and may be entered to the device via a keyboard or key pad or via voice commands, downloaded, transferred wirelessly or via wires, or in any other manner. The additional information is stored with the ancillary information retrieved from the digital tag. Additional information may include personalized content and may be added to the EXIF file along with the ancillary data at the same time the combined file is formed, and/or before and after. In this way, one or more digital rights or copy protection EXIF tags may be inserted into the combined EXIF file.

A combined file including visual data, ancillary information and possibly additional information may be stored in the device 102 and may be transmitted. Depending upon the receiving application, the combined file may be transmitted in full or it may be separated into component parts, and certain parts or all parts may be transmitted. The method queries whether to separate the full combined file into component parts 312. If the application receiving the transmission will utilize the full combined file, the component parts are not created 314 and the file is transmitted 316. For example, to transmit the combined file to a printer, or a computer connected to a printer, the file may be transferred in full. As will be discussed below, the full combined file may be manipulated by the printer, or the computer of the printer.

On the other hand, if the application receiving the transmission will utilize component parts of the combined file, the method includes separating the combined file 306 into component parts 318. That is, in the event that the receiving application cannot or will not separate component parts from one and other, then the method includes, prior to transmission, separating the combined file into component parts and then transmitting either all of the component parts of some of the component parts 320. The application or the equipment receiving the transmission can provide its capabilities to the source which could be a wireless communication device or the like and depending on the capabilities the source can separate the combined file 306 or transmit a portion thereof.

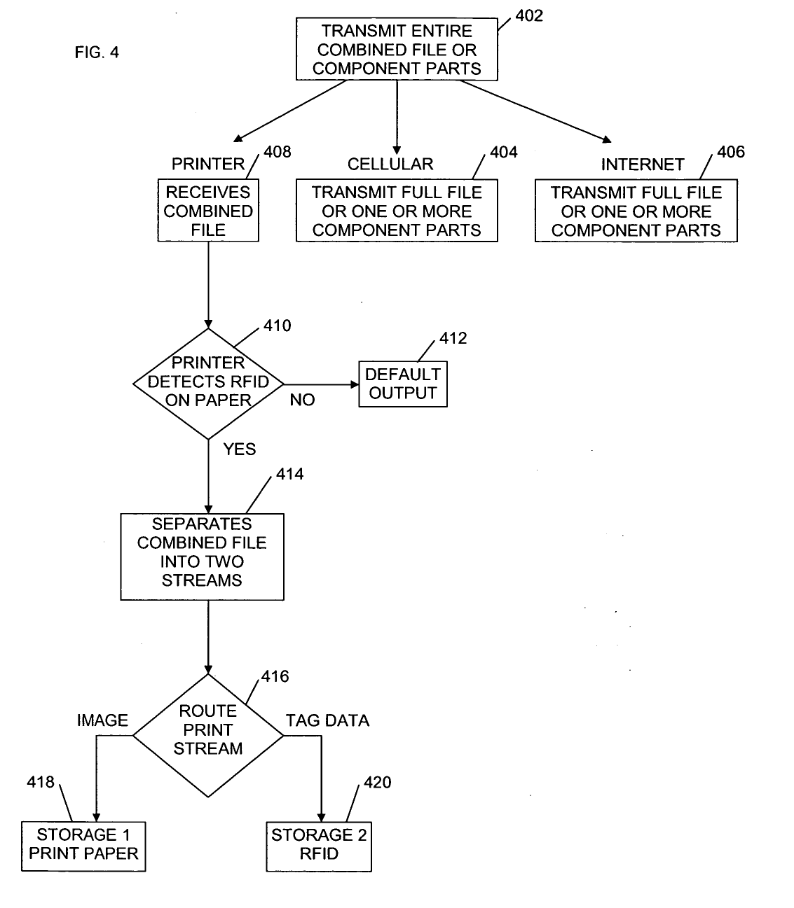

Now referring to FIG. 4, the communication device 102 can transmit 402 the entire combined file or all or some of the component parts of the combined file 306. In one embodiment, the transmission is received via cellular service or via Wi-Fi or the like. The communication device 102 may transmit 404 the combined file 306 or portions thereof to another communication device. The receiving application may display the image or sequence of images and read and/or write the combined ancillary information. Furthermore, additional ancillary information may be added to the combined file or components of the combined file by the receiving device.

In another embodiment the data of the RFID tag may trigger a communication device to access an Internet website 406, manually or automatically. A website address may be part of the ancillary information, and may be accessed when the ancillary information is read by the scanner, later when stored in the device and/or when accessed from the memory. In that case, certain ancillary information may be transmitted to a receiving application. The full combined file may not necessarily be transmitted.

The transmission or connection to a website address that is has a URL embedded in the signal of a digital tag read by the scanner of the device substantially synchronously with the capture of an image or sequence of an image can provide access to products, services and further ancillary information. Data from a website may be transferred to the device upon request or by push technology. In this manner, information from the digital tag, relevant to the image captured may provide a mechanism for enhanced Internet and/or cellular communications with a communication device.

An example scenario of the enhanced Internet and/or cellular communication described above, is the event where a soccer fan may attend a soccer game at a stadium. During the course of the match, the fan captures an image of a player and also receives ancillary information about the shoes that the player is currently wearing. A hyperlink may be displayed on the communication device display apparatus. The fan may click on the hyperlink or the device is configured to automatically launch the hyperlink through a browser on a device or any internet capable application on the device and place an order for the same shoes, substantially instantaneously or in the course of navigating the website.

Accordingly, the multimedia source (the player or other similar individuals such as celebrities) could push via the digital tag data, advertisements associated with their appearance such as ring-tones and hyperlinks that carry information about their products or products with which they are associated. Communication via a hyperlink based on digital tag data may further aid in keeping track of revenue generated from various advertising sources.

In another embodiment, a receiving application such as a printer 408 may apply the method described herein of separating the combined file into component parts after transmission. It is understood that in any case, a combined file 306 may be transmitted in its entirety, or some or all parts of a separated combined file 306. An example embodiment of the case where the combined file 306 is transmitted in its entirety, is when it is sent to a printer or a computer in communication with a printer 408. In transferring the combined file 306 to a printer, or a computer connected to a printer, where the image data of the combined file can be printed to paper, the ancillary information can be transferred to an RFID tag embedded into the paper as well. Accordingly, the image on the paper may then contain a copyright notice and/or a form of copy protection. The receiving printing application of a computer in communication with a printer may translate the combined file format to a printer readable format so that the printer may print an image file and transfer the ancillary information (including additional information) to an embedded RFID tag. Furthermore, additional ancillary data may be added to the combined file or components of the combined file by the computer of the printer.

After a printer or the printer computer receives a transmitted combined file that includes ancillary information including user preferred content (additional information), it queries 410 as to whether the printer paper includes an embedded RFID tag. If not, the printer prints according to its default settings 412. If the query generates a positive response, then the printing application can separate 414 the combined file into two information streams that are routed 416 to their appropriate output device. The image information stream is sent to the storage for the printer paper output 418 and the ancillary information stored in the tags of the EXIF file is sent to the storage 420 for transferring the data to an RFID tag embedded in the printer paper.

In this manner, photo albums may contain metadata in the print paper so that RFID readers can voice annotate or print annotate the hidden content. The ancillary data (including additional data) may be preserved over generations. Communication devices such as cellular telephones may be used to read the RFID tags of the photo album.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. In a mobile communication device, a method for capturing and transmitting data, the method comprising:
capturing an image to generate a data file;
capturing ancillary data embedded in a signal of a digital tag to retrieve the data of the digital tag substantially synchronously with capturing the image;
processing the ancillary data of the digital tag to combine it with the data file to generate a combined file; and
transmitting the combined file.

2. A method as recited in claim 1, further comprising;
receiving the combined file; and
separating the data file from the ancillary data of the signal of the digital tag.

3. A method as recited in claim 1, wherein a printer comprises digital tag encoding capability and a printer paper includes an embedded digital tag, the method further comprising;
printing indicia of the data file; and
storing the at least a portion or all of the ancillary data of the signal of the digital tag on the embedded digital tag.

4. A method as recited in claim 1 wherein data of the signal of the digital tag comprises digital rights data.

5. A method as recited in claim 1, further comprising:
separating the combined file into a plurality of component parts;
transmitting a portion or all one or more of the component parts.

6. A method as recited in claim 1 further comprising:
filtering the data of the digital tag.

7. A method as recited in claim 1 further comprising:
processing additional information to combine the additional information with the ancillary information.

8. A method as recited in claim 1 wherein the communication device is a cellular telephone.

9. In an image capturing device, a method for capturing and transmitting data, the method comprising:
capturing an image to generate an data file;
capturing ancillary data embedded in a signal of a digital tag to retrieve the data of the digital tag substantially synchronously with capturing the image; and
processing additional information to combine the additional information the data file and the ancillary data of the digital tag to form a combined filed.

10. A method as recited in claim 8, the method further comprising;
receiving the combined file; and
separating the combined file into the data file from the data of the digital tag and the additional information.

11. A method as recited in claim 10, wherein a printer comprises digital tag encoding capability and a printer paper includes an embedded digital tag, the method further comprising;
printing the data file; and
storing the ancillary data of the digital tag and the additional information on the embedded digital tag.

12. A method as recited in claim 8, further comprising:
separating the combined file into a plurality of component parts;
transmitting one or more of the plurality of component parts of the combination file via an Internet channel.

13. An image capturing device, comprising:
an image capturing module for capturing an image to generate an data file;
a data capturing module for capturing ancillary data embedded in a signal of a digital tag to retrieve the data of the digital tag substantially synchronously with capturing the image; and
a processing module for processing additional information to combine the additional information the data file and the ancillary data of the digital tag to form a combined filed.

14. A device as recited in claim 13, further comprising:
a transmission module for transmitting the combined file.

15. A device as recited in claim 13 wherein the combined file is metadata.

16. A device and printer as recited in claim 13, wherein a printer comprises digital tag printing capability and a printer paper comprises an embedded digital tag, the printer comprises;
a receiving module for receiving the combined file;
a separating module for separating the data file from the ancillary data of the digital tag and the additional information; and
a transferring module for transferring the ancillary data of the digital tag and the additional information to the embedded digital tag of the paper.

17. A device as recited in claim 13 wherein the digital tag is an RFID tag.

18. A device as recited in claim 14, further comprising:
an Internet transmission module for transmitting one or more component parts of the combined file via the Internet.

19. A device as recited in claim 14 wherein the data of the combined file comprises digital rights data.

20. A device as recited in claim 13 further comprising:
a filtering module for filtering the data of the digital tag.

21. A device as recited in claim 13 wherein the data file is a JPEG file.

22. A device as recited in claim 13 wherein the image capturing device is a mobile communication device.
